(19) United States
(12) Patent Application Publication
(10) Pub. No.: US 2017/0198869 A1
(43) Pub. Date: Jul. 13, 2017

(54) Multi-Tube LED Lighting Device

(71) Applicant: Aleddra Inc., Renton, WA (US)

(72) Inventors: Chia-Yiu Maa, Bellevue, WA (US); Chun-Te Yu, Renton, WA (US)

(21) Appl. No.: 14/995,142

(22) Filed: Jan. 13, 2016

(51) Int. Cl. F21K 99/00; F21V 23/06; F21V 23/00

(52) U.S. Cl. CPC F21K 9/30; F21K 9/50; F21V 23/003; F21V 23/06

(57) ABSTRACT

A lighting device may include a driver base and a plurality of elongated light tubes. The driver base may include a driver configured to convert an external alternating-current (AC) power to a direct-current (DC) power and supply the DC power to the plurality of elongated light tubes. A first side of the driver base may have an electric connector connecting to an external AC power source. Each of the plurality of elongated light tubes may protrude independently out of a second side of the driver base. An aggregate lighting angle of the plurality of elongated light tubes may be 360 degrees.

### TECHNICAL FIELD

The present disclosure pertains to the field of lighting devices and, more specifically, proposes a multi-tube light-emitting diode (LED) lighting device.

### BACKGROUND

Edison-base and PL-base compact fluorescent (CFL) lamps have been widely used for commercial lighting in luminaires such as recessed can fixture, surface-mount ceiling fixture, decorated wall-mount fixture, and even exterior wall pack fixture. For PL-based CFL lamps, they usually take the form of 2-tube, 4-tube, or even 6-tube. While the PL-based CFL lamp saves energy as compared to the incandescent lamp, it has several drawbacks. Firstly, it takes some time to warm up, thus it can't put out 100% light immediately upon turning on. Secondly, its lifetime affects by the on-off cycle. While it could save energy when using the PL-based CFL lamp together with a motion sensor, the frequent on-off cycles due to motion-sensing has negative impact on lamp's life. Thirdly, the lifetime of CFL lamp at 6,000 to 8,000 hours is not long enough, thus its replacement becomes one of the major lighting maintenance tasks for commercial facility management team.

LED technology has been applied to PL-base lamps recently. However, due to the directional lighting nature of the LED light source, the PL-base LED has the limitation of producing one directional lighting, as opposed to the omnidirectional lighting by the CFL lamp. Thus PL-base LED lamp used in a CFL fixture, it can't replicate the same lighting distribution as of the CFL lamp. Moreover, the PL-base socket can be either horizontally or vertically aligned. No one PL-based LED lamp can be used in both scenarios. Two types of PL-based LED lamp, the horizontal-mount type and the vertical-mount type, were devised to meet this mounting needs, which resulting additional inventory cost of stock both types of PL-based LED lamp.

The present disclosure presents a multi-tube LED lamp that mimics the form factor of the PL-based CFL lamp by using filament LED inside of each tube for producing 360-degree lighting angle, thus overcoming all drawbacks mentioned above with the CFL lamp and the LED-diode based PL lamp.

### SUMMARY

In one aspect, the lighting device that comprises a driver base and more than one elongated DC-powered light tubes. The driver base contains a driver for converting external AC power to DC power and then supplying DC power to power the more than one elongated light tubes. One side of the driver base has an electric connector for connecting to external power source. The more than one elongated DC-powered light tubes protrude independently out of another side of the driver base. Moreover, the aggregate lighting angle of the more than one elongated DC-powered light tubes is 360 degree.

Unlike conventional LED tubular lamp that normally comprises of only one LED lighting surface, the present disclosure has multiple light tubes thus having two advantages over traditional single tube design. Firstly, each light tube cab be independent oriented, thus widening the overall lighting angle of the lighting device to 360 degree even though the lighting angle of each individual lighting is less than 360 degree. Secondly, each light tube has its own lighting surface, thus increasing the overall lighting surface area, as well as increasing the overall heat dissipation area, with the benefit of better heat management and longer lifetime for the lighting device that uses heat-sensitive light source such as LED.

In some embodiments, the side of the driver base that has the electric connector is on the opposite side of the driver base where the more than one elongated light tubes protrude out of. This is the case with the standard tubular-style PL-based CFL lamps where the multiple lighting tubes protrude out of the opposite side of the base where the power connecting pins.

In some embodiments, the side of the driver base that has the electric connector is perpendicular to the side of the driver base where the more than one elongated light tubes protrude out of. This the case when the lighting tubes are vertically situated whereas the electric connector plugs into a wall socket horizontally.

In some embodiments, the more than one than one elongated light tubes may be of the same length. In some other embodiments, the light tubes may be of different length for special lighting application or for aesthetic reason.

Similarly, in some embodiments, the more than one than one elongated light tubes may be aligned in parallel. In some other embodiments, e.g. for special lighting application or for aesthetic reason, the multiple light tubes may be aligned in non-parallel fashion.

In some embodiments, at least one pair of the elongated light tubes may be connected on the end that is away from the driver base, thus forming a U-bend light tube.

In some embodiments, the more than one elongated LED light tube each has a lighting angle greater than 180 degree. This ensures each elongated LED light tube has wide enough lighting angle individually, and the aggregated lighting angle of these light tubes is 360 degree and the light is evenly distributed in all direction.

In some embodiments, the more than one elongated light tube each comprises an elongated lens cover and at least one light source, and the light source is enclosed by the elongated lens cover. While this is likely to be the most popular embodiment, it is possible to design an elongated light tube using no lens cover, using non-elongated lens cover, or using an elongated lens cover that doesn't enclose the light source completely. It is even foreseeable to apply the light source on the outside surface of the elongated lens cover when using an organic LED (OLED) light source.

In some embodiments, the lens cover may be transparent or translucent or partially transparent and partially translucent. When needed, as in some other embodiments, a filtering material may be applied to the lens cover for filtering the light emitted out of the light source.

In some embodiments, a reflective material may be applied to the lens cove for increasing the lighting angle of the light source to greater than 180 degree. This is needed for achieving a greater than 180 degree lighting angle for the light tube when the light source in use has a smaller natural lighting angle. For example, the natural lighting angle for an LED diode is 120 degree. For a light tube to achieve a greater than 180 degree lighting angle, a reflective material needs to be applied to the lens cover, thus making it as a kind of diffuser.

In some embodiments, the space between the lens cover and the light source may be vacuum or filled with inert gas. This increase the safety of the lighting device.

In some embodiments, the driver may be an LED driver and the light source may be a filament-style LED light source with a greater than 180 degree lighting angle.

In some embodiments, the driver may be an LED driver and the light source may be an LED light source aligned in an elongated fashion and the elongated lens covers is applied with a reflective material to function as a diffuser to the light source for producing a greater than 180 degree lighting angle.

In some embodiments, the driver may be an OLED driver and the light source may be an OLED light source aligned in an elongated fashion and the elongated lens covers is applied with a reflective material to function as a diffuser to the light source for producing a greater than 180 degree lighting angle.

In some embodiments, the driver may be a non-LED driver and the light source may be a DC-powered non-LED light source aligned in an elongated fashion and the elongated lens covers is applied with a reflective material to function as a diffuser to the light source for producing a greater than 180 degree lighting angle.

In some embodiments, the electric connector may take the form of any screw-in base (e.g., Edison-based E13/E26/E39, etc.), pin-base (e.g., PL, MR16, GU10, etc.), hole-base socket connector, any standard or non-standard electrical connector, or any combination thereof.

In some embodiments, the more than one elongated DC-powered light tubes may form a driver-less sub-assembly, and the driver base itself may form another sub-assembly. The two sub-assemblies may be combined through a locking mechanism without using an external force or an additional part or component. One benefit of having such design is that it easier to detach and replace the driver base when it dies. This is because the driver lifetime is less than that of the LED diodes and tubes. With a plug-and-play replaceable driver base, the lifetime of the lighting device can be extended without replacing it completely. Another benefit of such design is that the end user can upgrade the driver base with a new functionality becomes available. For example, the original driver base may not have the dimming capability. The next generation driver base may be dimmable. Or the original driver base may not be controllable via a wireless control, while the new driver base is wireless controllable via a smartphone app, for example. With a plug-and-playable locking mechanism or interface between the multi-tube assembly and the driver base assembly, the driver base is upgradeable easily and cost-effectively.

In some embodiments, the plug-and-playable locking mechanism may include, but not limited to Edison base sockets, PL sockets, MR16 sockets, GU10 sockets, BIAX sockets, and any standard non-standard base locking electrical sockets, or any combination thereof.

### BRIEF DESCRIPTION OF THE DRAWINGS

The accompanying drawings are included to aid further understanding of the present disclosure, and are incorporated in and constitute a part of the present disclosure. The drawings illustrate a select number of embodiments of the present disclosure and, together with the detailed description below, serve to explain the principles of the present disclosure. It is appreciable that the drawings are not necessarily in scale as some components may be shown to be out of proportion than the size in actual implementation in order to clearly illustrate the concept of the present disclosure.

FIG. 1A schematically depicts a diagram of a 4-tube LED lighting device with 2-pin PL base in accordance with the present disclosure.

FIG. 1B schematically depicts a driver connection diagram of a 4-tube LED lighting device in accordance with the present disclosure.

FIG. 2A schematically depicts a diagram of a 6-tube LED lighting device with 2-pin PL base in accordance with the present disclosure.

FIG. 2B schematically depicts a driver connection diagram of a 6-tube LED lighting device in accordance with the present disclosure.

FIG. 3A schematically depicts a diagram of an 8-tube LED lighting device with 2-pin PL base in accordance with the present disclosure.

FIG. 3B schematically depicts a driver connection diagram of an 8-tube LED lighting device in accordance with the present disclosure.

FIG. 4 schematically depicts another embodiment of the present disclosure.

### DETAILED DESCRIPTION OF PREFERRED EMBODIMENTS

### Overview

Various implementations of the present disclosure and related inventive concepts are described below. It should be acknowledged, however, that the present disclosure is not limited to any particular manner of implementation, and that the various embodiments discussed explicitly herein are primarily for purposes of illustration. For example, the various concepts discussed herein may be suitably implemented in a variety of lighting devices having different form factors.

The present disclosure discloses a lighting device that comprises a driver base and more than one elongated DC-powered light tubes. The driver base contains a driver for converting external AC power to DC power and then supplying DC power to power the more than one elongated light tubes. One side of the driver base has an electric connector for connecting to external power source. The more than one elongated DC-powered light tubes protrude independently out of another side of the driver base.

### Example Implementations

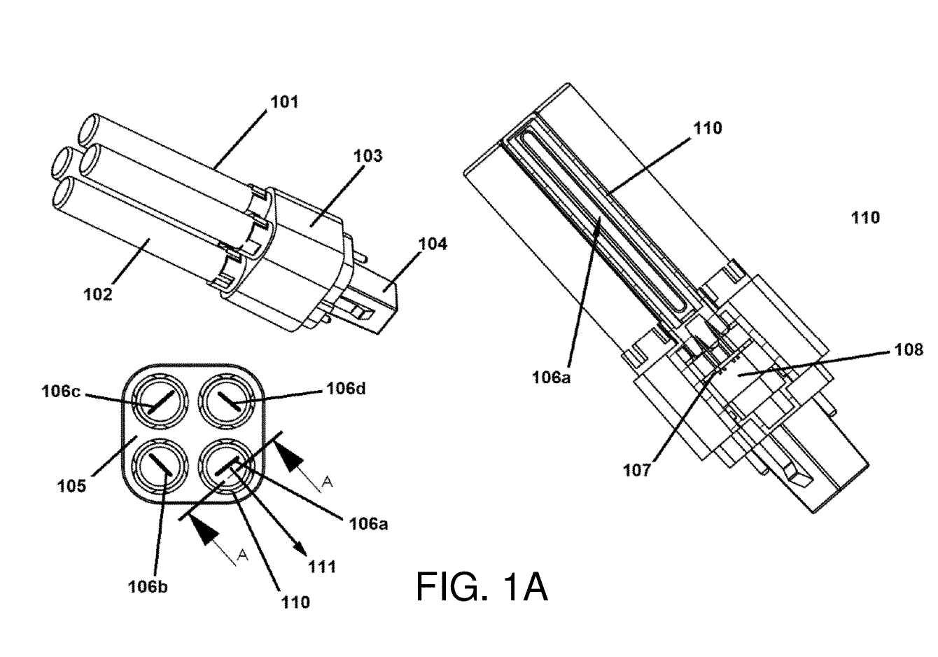

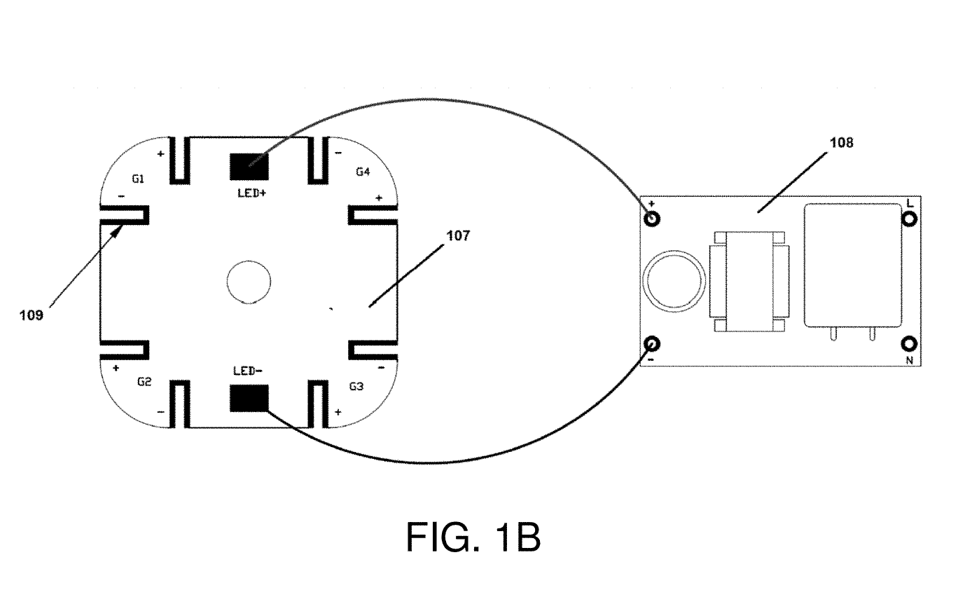

FIGS. 1A and 1B illustrate one non-limiting embodiment of the multi-tube lighting device of the present disclosure. This lighting device 101 comprises four DC-powered light tubes 102 and one driver base 103. The four light tubes 102 protrude out of one side of the driver base 103 independent of each other as shown in the tube mounting pattern 105. On the opposite side of the driver base 103 is the 2-pin PL-base connect connector 104. Taking a cross section view of the 4-tube lighting device as indicated by the “A-A” cutting line on the tube mounting pattern 105, one of the four elongated LED light sources 106a is shown to be enclosed by the elongated lens cover 110. The other three LED light sources 106b, 106c, and 106d are enclosed by their corresponding lens covers. A PCB board 107 is used for mounting each of the four filament LED light sources 109 onto the DC connector slots G1, G2, G3, and G4. The PCB board 107 is then wired to the LED driver 108. Both the PCB board 107 and the driver 108 reside inside the driver base 103.

The four light tubes 102 emitting light independently of each other, thus having the benefit of widening the overall lighting angle of the 4-tube lighting device. Moreover, each light tube has its own lighting surface, thus increasing the overall lighting surface area, as well as increasing the overall heat dissipation area, with the benefit of better heat management and longer lifetime for the LED light source.

The light tubes 102 and the PL connector 104 are on the opposite of the base connector 103. In some embodiments, the driver base surface for mounting the light tubes is perpendicular to the driver base surface. For example, a standard electric socket plug can protrude out the surface denoted by 103, thus perpendicular to the surface for mounting the light tube 102, and the standard electric socket plug can be plugged into an 110V AC wall socket.

All four tubes 102 shown in FIG. 1A are of the same length. In some embodiment, they may be of different length. Additionally, all tubes 102 shown in FIG. 1A are aligned in parallel. In some embodiments, they may be aligned in a non-parallel fashion. In some embodiments, a pair of the light tube are connected on the end that is away from the driver base, thus forming a U-bend tube.

The lens cover 110 can be transparent or translucent or partially transparent and partially translucent. When needed, as in some other embodiments, a filtering material may be applied to the lens cover for filtering the light emitted out of the LED light source. This will have the effect of softening the light output, removing undesirable light wave, or changing the color (temperature) of the light output.

For safety reason, the space between the lens cover 110 and the filament-style light source 106 is preferred to be of vacuum or filled with inert gas.

It is possible to use 360-degree light source for each of the four light tubes to achieve 360-degree lighting angle of the 4-tube LED lighting device. For a light source with a narrower lighting angle (e.g., 120-degree) but coupled a lens cover with a reflective material, it is possible to increase the lighting angle of the LED light tube to be greater than 180 degree. The LED light source 106 emits light only with a 120 degree lighting angle centered in the direction 111. However, the elongated lens cover 110 is applied with a reflective material making it a kind of diffuser, thus achieving a 180 degree lighting angle, 120 degrees clockwise to the direction 111 and 120 degrees counterclockwise to the direction 111. Similarly, the LED light sources 106b, 106c, and 106d each is facing away from the center of the driver base 103, and their lens covers are applied with a reflective coating, thus enabling every light tube to achieve 180 degree lighting angle, resulting the aggregate lighting angle of the 4-tube lighting device to be 360 degree. Since the LED light source is used for 106a, 106b, 106c, and 106d, the driver 108 in the driver base 103 is an LED driver in this embodiment.

In some embodiments, an OLED light source can be used and aligned in an elongated fashion and the elongated lens covers is applied with a reflective material to function as a diffuser to the light source for producing a greater than 180 degree lighting angle. Likewise, in some embodiments, a non-LED driver can be used with a DC-powered non-LED light source aligned in an elongated fashion and the elongated lens covers is applied with a reflective material to function as a diffuser to the light source for producing a greater than 180 degree lighting angle.

In FIG. 1A, the electric connector 104 takes the form of two-pin PL connector. It may be four-pin PL connector. In other embodiments, the electric connector can take the form of any screw-in base, pin-base, or hole-base socket connector, or any standard or non-standard electrical connector.

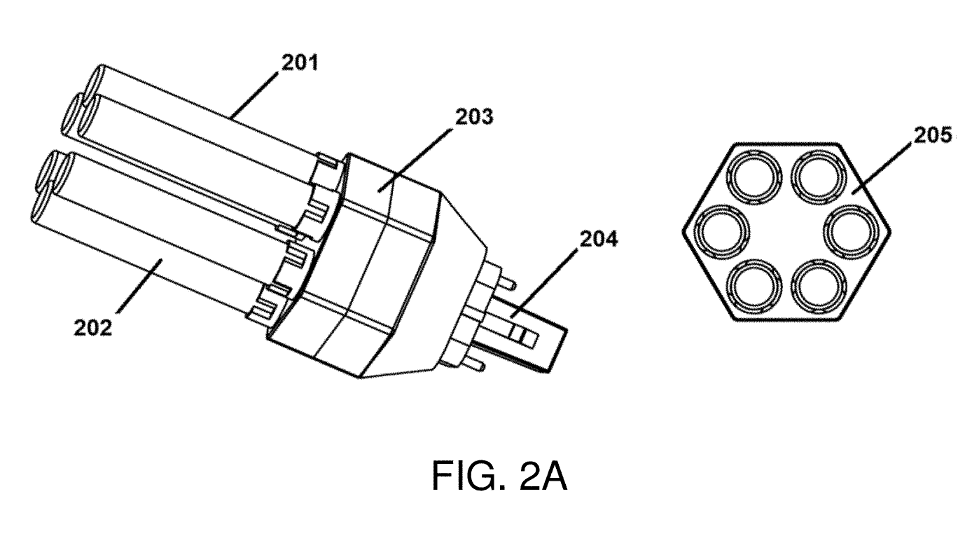

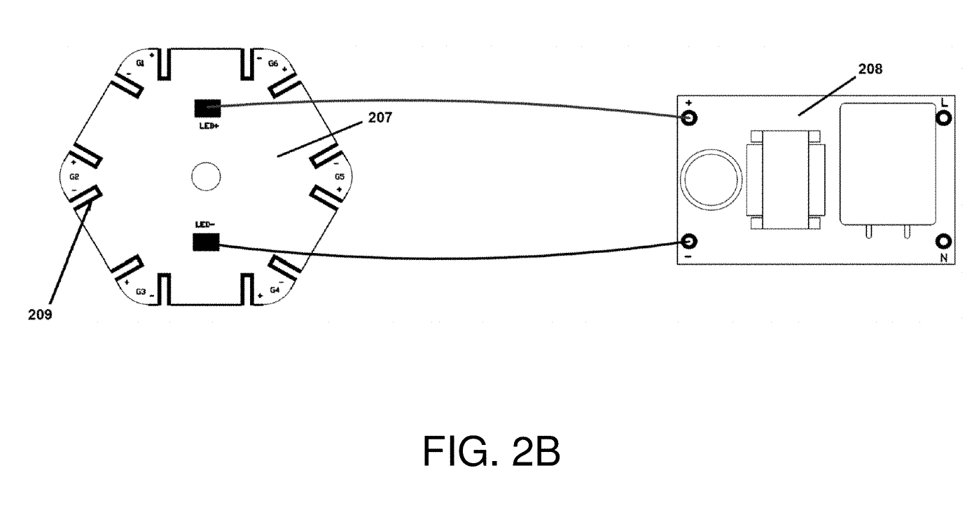

FIGS. 2A and 2B illustrate another embodiment of the multi-tube lighting device of the present disclosure. This lighting device 201 comprises six light tubes 202 and one driver base 203. The six light tubes 202 protrude out of one side of the driver base 203 independent of each other as shown in the tube mounting pattern 205. On the opposite side of the driver base 203 is the 2-pin PL-base connector 204. Though not shown in FIG. 2A, a PCB board 207 resides inside of the driver base 203 for mounting the elongated LED light source, and the LED driver 208 also resides inside the driver base 203. The PCB board 207 is used to mount six elongated LED lighting sources 209. The PCB board 207 is wired to the LED driver 208, and both reside inside the driver base 203.

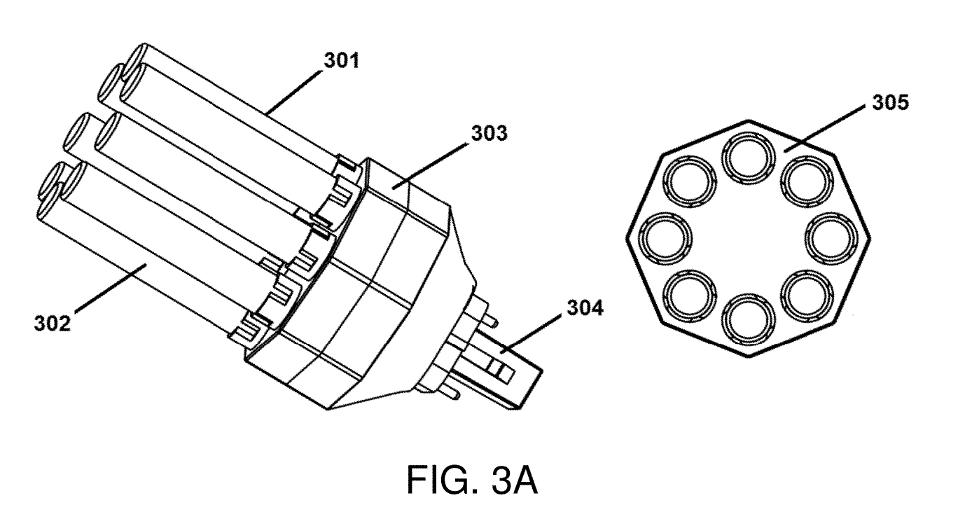

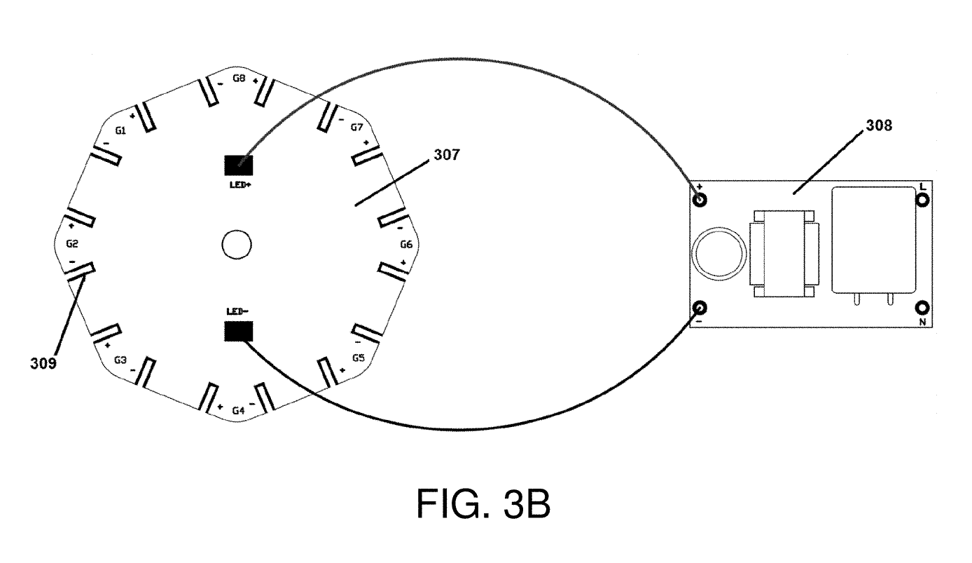

FIGS. 3A and 3B illustrate another embodiment of the multi-tube lighting device of the present disclosure. This lighting device 301 comprises eight light tubes 302 and one driver base 303. The eight light tubes 302 protrude out of one side of the driver base 303 independent of each other as shown in the tube mounting pattern 305. On the opposite side of the driver base 303 is the 2-pin PL-base connector 304. Though not shown in FIG. 3A, a PCB board 307 resides inside of the driver base 303 for mounting the elongated LED light source, and the LED driver 308 also resides inside the driver base 303. The PCB board 307 is used to mount eight elongated LED lighting sources 309. The PCB board 307 is wired to the LED driver 308, and both reside inside the driver base 303.

The mounting patterns of multiple light tubes in FIG. 1A 105, FIG. 2A 205, and FIG. 3A 305 are shown in circular fashion. Other mounting patterns are anticipated in order to (1) maximize the use of the mounting surface and the overall light output, or (2) create a particular lighting effect for aesthetic reason.

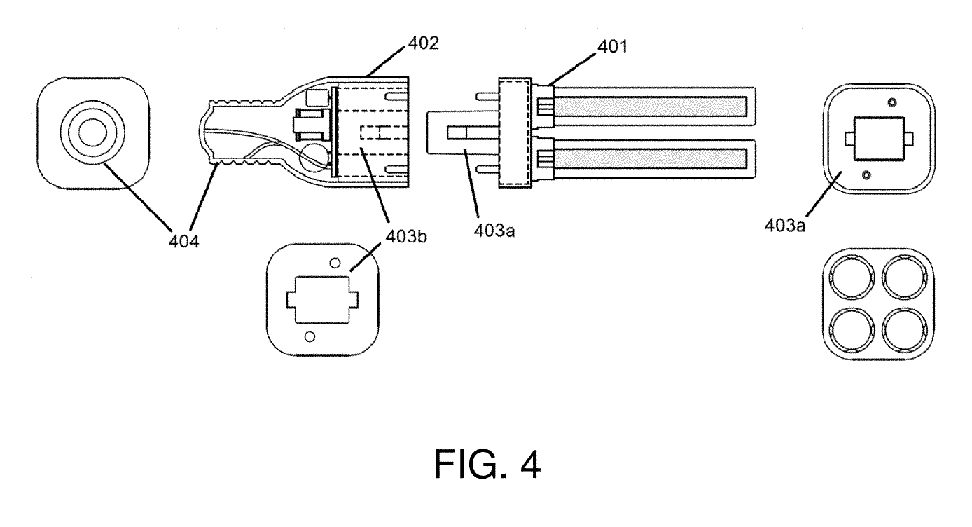

The FIG. 4 is another embodiment of the multi-tube lighting device of the present disclosure. The 4 tubes form a sub-assembly 401 and the driver base 402 itself another sub-assembly. These two sub-assemblies are combined through a PL socket connector 403a, 403b. No external force or additional part or component is needed for combing these two sub-assemblies. With this embodiment, the driver base can be easily upgraded with new functionality or replaced when the LED driver failed. The driver base connects to the external AC power source through a screw-in connector 404.

### Additional and Alternative Implementation Notes

Although the techniques have been described in language specific to certain applications, it is to be understood that the appended claims are not necessarily limited to the specific features or applications described herein. Rather, the specific features and examples are disclosed as non-limiting exemplary forms of implementing such techniques.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

What is claimed is:

1. A lighting device, comprising:
a driver base; and
a plurality of elongated light tubes,
wherein:
the driver base comprises a driver configured to convert an external alternating-current (AC) power to a direct-current (DC) power and supply the DC power to the plurality of elongated light tubes,
a first side of the driver base has an electric connector connecting to an external AC power source,
each of the plurality of elongated light tubes protrudes independently out of a second side of the driver base, and
an aggregate lighting angle of the plurality of elongated light tubes is 360 degrees.

2. The lighting device of claim 1, wherein the first side of the driver base is opposite to the second side of the driver base.

3. The lighting device of claim 1, wherein the first side of the driver base is perpendicular to the second side of the driver base.

4. The lighting device of claim 1, wherein the plurality of elongated light tubes are of a same length or of different lengths.

5. The lighting device of claim 1, wherein the plurality of elongated light tubes are aligned in a parallel fashion.

6. The lighting device of claim 1, wherein the plurality of elongated light tubes are aligned in a non-parallel fashion.

7. The lighting device of claim 1, wherein at least one pair of the elongated light tubes are connected on an end that is away from the driver base and form a U-bend light tube.

8. The lighting device of claim 1, wherein the plurality of elongated light tubes comprise light-emitting diode (LED) light tubes having a lighting angle greater than 180 degrees.

9. The lighting device of claim 1, wherein each of the plurality of elongated light tubes comprises an elongated lens cover and at least one light source which is enclosed by the lens cover.

10. The lighting device of claim 9, wherein the lens cover is transparent, translucent or partially transparent and partially translucent.

11. The lighting device of claim 9, wherein a filtering material is applied to the lens cover and configured to filter light emitted out of the light source.

12. The lighting device of claim 9, wherein a reflective material is applied to the lens cove and configured to increase a lighting angle of the light source to greater than 180 degrees.

13. The lighting device of claim 9, wherein a space between the lens cover and the light source is vacuum or filled with an inert gas.

14. The lighting device of claim 9, wherein the driver is a light-emitting diode (LED) driver and the light source is a filament-style LED light source with a lighting angle greater than 180 degrees.

15. The lighting device of claim 9, wherein the driver is a light-emitting diode (LED) driver and the light source is an LED light source aligned in an elongated fashion, and wherein the elongated lens cover is applied with a reflective material configured to function as a diffuser to the light source for producing a lighting angle greater than 180 degrees.

16. The lighting device of claim 9, wherein the driver is an organic light-emitting diode (OLED) driver and the light source is an OLED light source aligned in an elongated fashion, and wherein the elongated lens cover is applied with a reflective material configured to function as a diffuser to the light source for producing a lighting angle greater than 180 degrees.

17. The lighting device of claim 9, wherein the driver is a non-light-emitting diode (LED) driver and the light source is a DC-powered non-LED light source aligned in an elongated fashion, and wherein the elongated lens covers is applied with a reflective material configured to function as a diffuser to the light source for producing a lighting angle greater than 180 degrees.

18. The lighting device of claim 1, wherein the electric connector is in a form of any screw-in base, pin-base, hole-base socket connector, or any standard or non-standard electrical connector.

19. The light device of claim 1, further comprising a locking mechanism, wherein the plurality of elongated light tubes form a driver-less sub-assembly, wherein the driver base with the driver form another sub-assembly, and wherein the two sub-assemblies are combined through the locking mechanism without using an external force or an additional part or component.

20. The lighting device of claim 19, wherein the locking mechanism comprises one or more locking electrical sockets comprising Edison base sockets, PL sockets, MR16 sockets, GU10 sockets, BIAX sockets, any standard or non-standard base locking electrical sockets, or a combination thereof.
